(19) United States
(12) Patent Application Publication
(10) Pub. No.: US 2009/0077406 A1
(43) Pub. Date: Mar. 19, 2009

(54) Computer, Power Saving Method And Method For Reducing Output Current Of A Web Camera

(75) Inventor: Fong-Ming Chang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/233,647

(22) Filed: Sep. 19, 2008

(30) Foreign Application Priority Data
Sep. 19, 2007 (TW) 96134980

(51) Int. Cl. G06F 1/00

(52) U.S. Cl. 713/323

(57) ABSTRACT

A computer, a power saving method and a method for reducing output current are disclosed. The computer includes a driving module, an application module, and a daemon module. The driving module initializes the web camera when the web camera connects to the computer. When the web camera outputs signals to the application module, a signal channel is established. The daemon module detects the signal channel. When the signal channel stops, the daemon module set the web camera into the standby mode through the driving module.

### RELATED APPLICATIONS

This application claims priority to Taiwan Application Serial Number 96134980, filed Sep. 19, 2007, which is herein incorporated by reference.

### BACKGROUND

1. Field of Invention

The invention relates to a power saving method. More particularly, the invention relates to a power saving method of the web camera.

2. Description of Related Art

Generally speaking, one types of the web camera and the internet camera connect to a personal computer (PC) via USB in first, then connects to the Internet through the PC. This type of web cameras normally includes lenses, filters, image sensors, image digital elements, and the image compressor.

Another type of web cameras can connect to the Internet directly, without the PC. Such web camera has a built-in IP address to process the Internet communication protocol, such as TCP/IP. The network connection of these web cameras is the same as other network devices. Moreover, this type of web camera has web server, file transfer server, file transfer client, and E-mail client software. Advanced web camera servers have more attractive functions, such as motion detection, alarm input/output, and E-mail support.

As web cameras have been popular nowadays, saving the power consumption of the web camera becomes an important issue.

### SUMMARY

According to one embodiment of the present invention, a computer electrically connected with a web camera includes a driving module, an application module, and a daemon module. Once the web camera is electrically connected to the computer, the driving module initializes the web camera. When the web camera outputs signals to the application module, a signal channel is established. The daemon module detects the signal channel. When the signal channel stops, the daemon module sets the web camera into the standby mode through the driving module.

According to another embodiment of the present invention, the disclosed computer power saving method uses a driving module to initialize a web camera and sets the web camera to enter a standby mode. The method also use an application module to wake up the web camera, and establishes a signal channel between the application module and the driving module. Then, the method makes the web camera transmit a first resolution signal to the application module, and uses the application module to request an resolution adjustment of the web camera and. Then the method makes the web camera send a second resolution signal to the application module.

According to yet another embodiment of the invention, the disclosed computer power saving method uses a driving module to initialize a web camera and sets the web camera to enter a standby mode; uses an application module to wake up the web camera and establishes a signal channel. The method also uses a daemon module to detect if the signal channel stops, and sets the web camera to enter the standby mode when the application module stops the signal channel.

According to still another embodiment of the invention, the method of reducing the output current of a web camera establishes a signal channel between a driving module and an application module, in which the driving module drives the camera. The method also provides a daemon module to detect if the signal channel stops, and sets the web camera to enter the standby mode when the application module stops the signal channel.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows the block diagram depicting the computer and the web camera according to one embodiment of the present invention;

FIG. 2 shows a flowchart of the computer power saving method according to one embodiment of the present invention;

FIG. 3 shows a flow chart of the computer power saving method according to another embodiment of the invention; and

FIG. 4 shows a flowchart of the method for reducing the web camera output current according to yet another embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The computer, power saving method, and method for reducing the web camera output current in the following description detect the usage of a web camera and switch among different modes thereof according to the detecting result. The web camera is thus kept in the appropriate mode for reducing the power consumption.

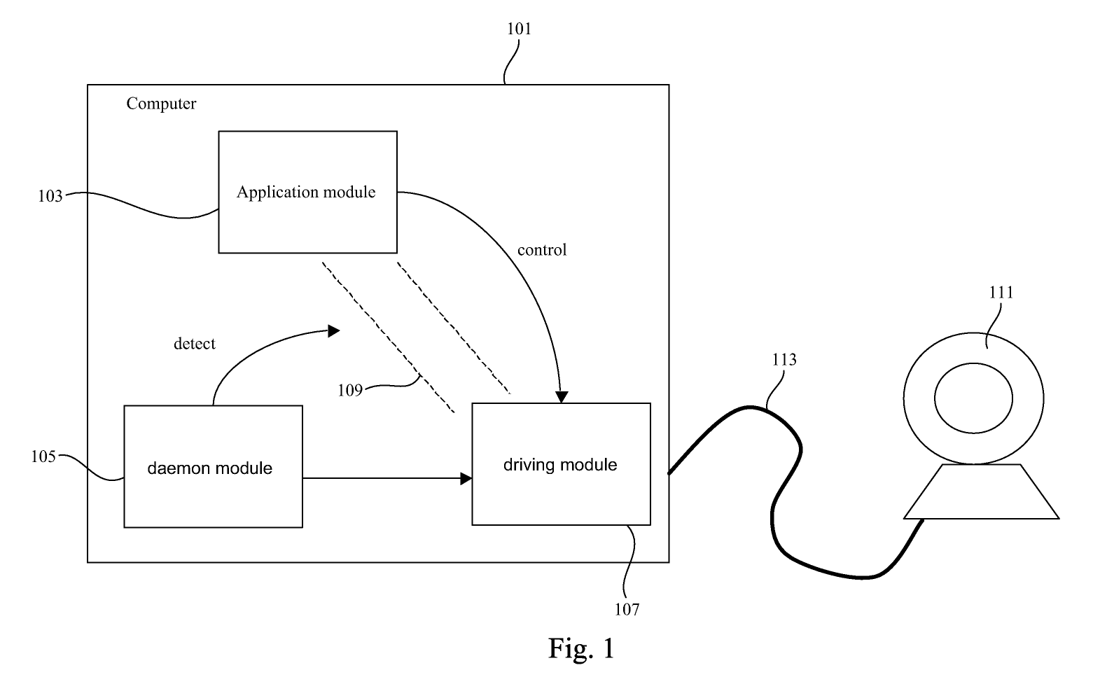

FIG. 1 shows the block diagram depicting the computer and web camera according to one embodiment of the invention. The web camera 111 electrically connects to the computer 101 via the interface 113. The interface 113 can be a universal serial bus (USB) interface. The computer 101 includes a driving module 107, an application module 103, and a daemon module 105. The driving module 107 and the daemon module 105 are installed to the computer in one installation procedure.

When the web camera 111 is electrically connected to the computer 101, the driving module 107 initializes the web camera 111. The initialization process includes an on/off test for the web camera 111, the initial value setting for the buffer of the web camera 111, and the address setting for the web camera 111. When the web camera 111 outputs a signal to the application module 103, a signal channel 109 is established between the application module 103 and the driving module 107. The signal channel 109 can be established with the handshaking technique. The daemon module 105 then detects the signal channel 109. When the signal channel 109 stops, the daemon module 105 sets the web camera 111 into the standby mode via the driving module 107. In the standby mode, the web camera 111 or parts circuit of the web camera 111 can be powered off to reduce the output current and the power consumption of the web camera.

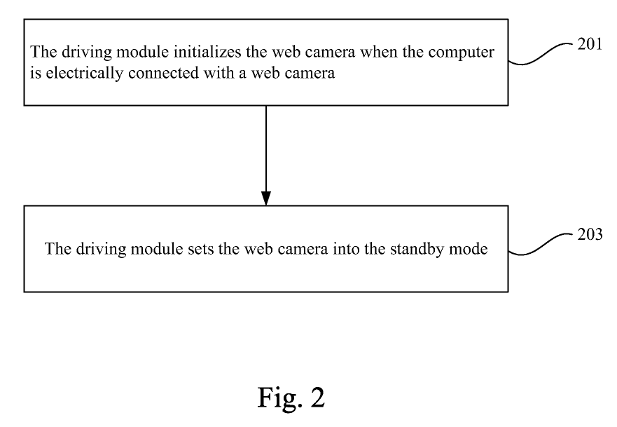

FIG. 2 shows a flowchart of the computer power saving method according to one embodiment of the present invention. When the computer is electrically connected with a web camera, the driving module initializes the web camera (step 201). Afterwards, the driving module sets the web camera into the standby mode (step 203) to reduce the output current and power consumption of the web camera. After the web camera enters the standby mode, the processor of the web camera can be turned off to stop processing images. Therefore, the power consumption of the computer can be reduced.

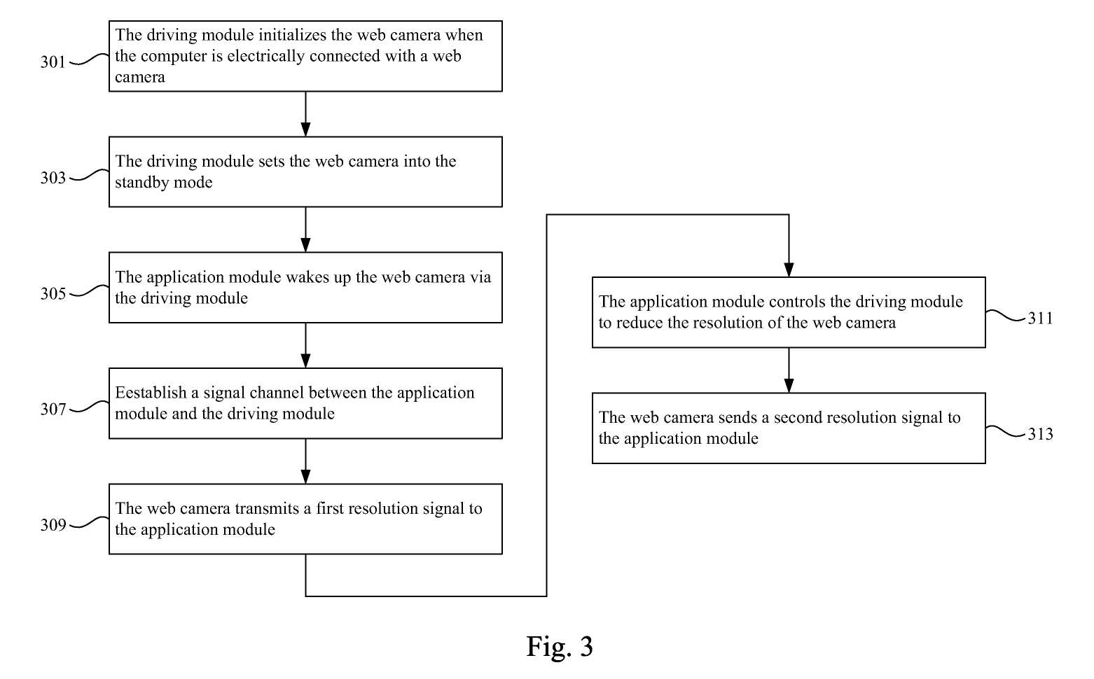

FIG. 3 shows a flow chart of the computer power saving method according to another embodiment of the invention. When the computer is electrically connected with a web camera, the driving module initializes the web camera (step 301). Afterwards, the driving module sets the web camera into the standby mode (step 303). Then, the application module wakes up the web camera via the driving module (step 305).

After the web camera is awake, a signal channel is established between the application module and the driving module (step 307). The web camera transmits a first resolution signal to the application module (step 309). After the application module receives the first resolution signal, the application module determines whether to reduce the resolution of the web camera. If the resolution of the web camera needs to be reduced, the application module controls the driving module to reduce the resolution of the web camera (step 311). After that, the web camera sends a second resolution signal to the application module (step 313) to notify the application module that the resolution has been reduced. Here the first resolution signal indicates a greater resolution than the second resolution signal. While adjusting the resolution, the web camera can be set in the power saving mode so that it does not output any signal. This reduces the output current and the power consumption of the web camera.

Particularly, when a web camera with a 2M pixel resolution is in use, the output current is about 225 to 250 mA. When the resolution is adjusted to 0.48M pixels, the output current is about 180 to 200 mA. In the standby mode, there is no pixel output and the web camera output current is about 50 to 70 mA.

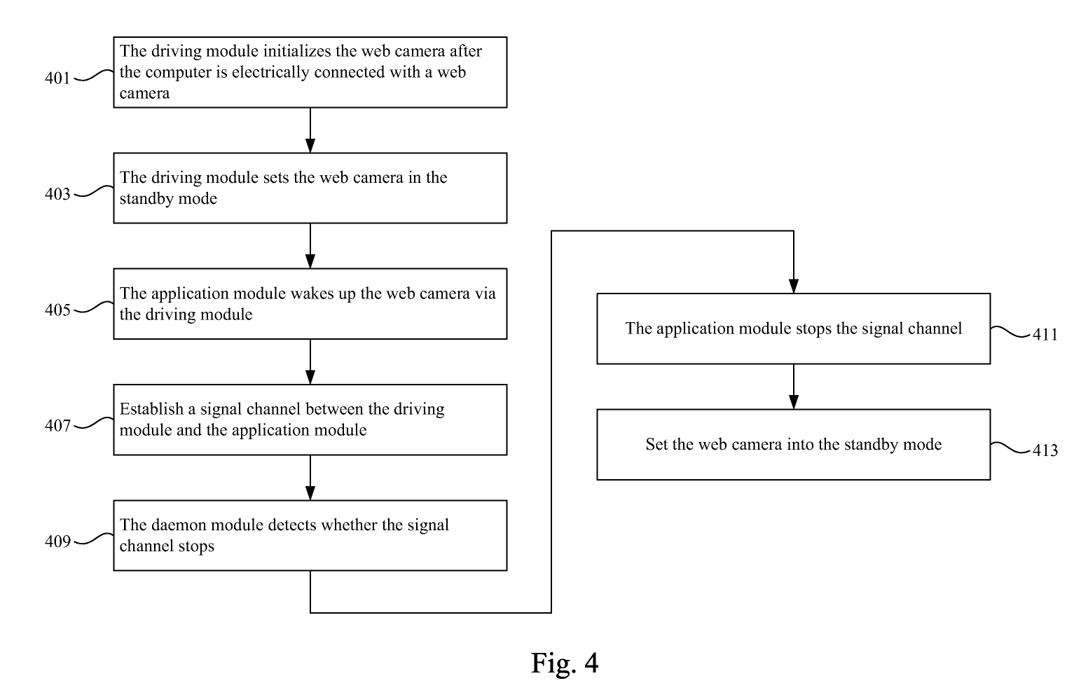

FIG. 4 shows a flowchart of the method for reducing the web camera output current according to still another embodiment of the present invention. After the computer is electrically connected with a web camera, the driving module initializes the web camera (step 401). The driving module sets the web camera in the standby mode (step 403). Afterwards, the application module wakes up the web camera via the driving module (step 405) and establishes a signal channel between the driving module and the application module (step 407). The driving module drives the web camera. The daemon module detects if the signal channel stops (step 409). When the application module stops the signal channel (step 411), the web camera is set into the standby mode (step 413). When the web camera is in the standby mode, part circuits of the web camera can be turned off to reduce the output current.

When the application module wakes up the web camera through the driving module (step 405), the web camera sends a first resolution signal to the application module. The application module determines whether to reduce the resolution of the web camera accordingly. If the resolution of the web camera needs to be reduced and the reducing process is done, the web camera sends a second resolution signal to the application module in order to notify that the resolution has been reduced. When the resolution is reduced, the web camera enters a power saving mode to reduce its output current.

According to the above-mentioned embodiments, the disclosed computer, power saving method, and method for reducing the web camera output current can detect the state of the web camera and switches the web camera into an appropriate mode accordingly to reduce the power consumption thereof.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer, which electrically connected with a web camera, comprising:
a driving module for initializing the web camera when the web camera connects to the computer;
an application module for controlling the driving module, wherein the application module establishes a signal channel when the web camera outputs signals to the application module; and
a daemon module for detecting the signal channel and setting the web camera into a standby mode through the driving module when the signal channel stops.

2. The computer of claim 1, wherein the driving module and the daemon module are installed to the computer in one installation procedure.

3. The computer of claim 1, wherein a processor of the web camera is turned off and stops processing images when the web camera enters the standby mode for reducing the power consumption.

4. A power saving method for a computer electrically connected with a web camera, the method comprising:
initializing the web camera by a driving module;
setting the web camera into a standby mode;
waking up the web camera by an application module;
establishing a signal channel between the application module and the driving module;
sending a first resolution signal from the web camera to the application module;
requesting to adjust the resolution of the web camera by the application module; and
sending a second resolution signal from the web camera to the application module.

5. The method of claim 4, wherein the resolution represented by the first resolution signal is greater than the resolution represented by the second resolution signal.

6. A power saving method for a computer, the computer electrically connects with a web camera, the method comprising:
initializing the web camera by a driving module;
setting the web camera into a standby mode;
waking up the web camera by an application module;
establishing a signal channel; and
providing a daemon module to detect if the signal channel stops and selectively setting the web camera into a standby mode when the application module stops the signal channel.

7. A method for reducing the output current of a web camera electrically connected to a computer, the method comprising:
establishing a signal channel between a driving module and an application module, wherein the driving module drives the web camera; and
providing a daemon module to detect if the signal channel stops and selectively setting the web camera into a standby mode when the application module stops the signal channel.

8. The method of claim 7, wherein a circuit of the web camera is turned off when the web camera is in the standby mode to reduce the output current thereof.

9. The method of claim 7, further comprising:
waking up the web camera by the application module;
sending a first resolution signal from the web camera to the application module;
requesting to adjust the resolution of the web camera by the application module; and
sending a second resolution signal from the web camera to the application module,
wherein the resolution represented by the first resolution signal is greater than the resolution represented by the second resolution signal.

10. The method of claim 9, wherein the web camera enters the standby mode to reduce output current when the web camera adjusts the resolution.

11. The method of claim 7, wherein establishing the signal channel is performed with handshaking technique.
